(19) United States
(12) Patent Application Publication
(10) Pub. No.: US 2023/0286870 A1
(43) Pub. Date: Sep. 14, 2023

(54) LASER ASSISTED SOLID FREEFORM FABRICATION OF CERAMIC MATERIALS VIA TEMPERATURE SENSITIVE SLURRIES

(71) Applicant: UNIVERSITY OF FLORIDA RESEARCH FOUNDATION, INCORPORATED, Gainesville, FL (US)

(72) Inventors: Wolfgang M. SIGMUND, Gainesville, FL (US); Franziska SCHMIDT, Berlin (DE); Jens GUENSTER, Berlin (DE); Andrea ZOCCA, Berlin (DE)

(21) Appl. No.: 18/015,395

(22) PCT Filed: Jul. 12, 2021
(86) PCT No.: PCT/US2021/041261

§ 371 Date: Jan. 10, 2023

Related U.S. Application Data
(60) Provisional application No. 63/050,529, filed on Jul. 10, 2020.

(51) Int. Cl. C04B 35/626; C04B 35/111; C04B 35/565; C04B 35/624; C04B 35/64; C04B 35/634; B28B 1/00; B33Y 10/00; B33Y 70/00

(52) U.S. Cl. CPC C04B 35/62695; C04B 35/111; C04B 35/565; C04B 35/624; C04B 35/62655; C04B 35/64; C04B 35/63492; C04B 35/63448; C04B 35/6264; B28B 1/001; B33Y 10/00; B33Y 70/00; C04B 2235/3217; C04B 2235/3817; C04B 2235/6023; C04B 2235/612; C04B 2235/95; B33Y 40/20

(57) ABSTRACT

Disclosed embodiments relate to gelling aqueous ceramic slurries with temperature using laser-assisted free-forming to provide a break-through of rapidly making ceramics from slurries and computer assisted design files. Methods according to various embodiments are superior to any other since no toxic materials are used. The slurries are made with edible and safe compounds.

### BACKGROUND

A need exists for solid freeform fabrication of ceramic materials. The discussion of shortcomings and needs existing in the field prior to the present invention is in no way an admission that such shortcomings and needs were recognized by those skilled in the art prior to the present disclosure.

### BRIEF DESCRIPTION OF THE FIGURES

Many aspects of this disclosure can be better understood with reference to the following figures.

FIG. 1 is an example according to various embodiments illustrating a flow chart of a method for laser-assisted solid freeform fabrication of ceramic materials via temperature sensitive slurries.

FIGS. 2A-2H illustrate various steps and products produced as described in the Example 1.

FIGS. 3A-3B illustrate various steps and products produced as described in Example 2.

FIGS. 4A-4B illustrate various steps and products produced as described in the Example 3.

FIG. 5 provides a table of the materials used in Examples 1-12.

FIG. 6 is a block diagram that illustrates a computer system upon which an embodiment of the invention may be implemented.

FIG. 7 illustrates a chip set upon which an embodiment of the invention may be implement.

It should be understood that the various embodiments are not limited to the examples illustrated in the figures.

### DETAILED DESCRIPTION

### Introduction and Definitions

Various embodiments may be understood more readily by reference to the following detailed description. Unless defined otherwise, all technical and scientific terms used herein have the same meaning as commonly understood by one of ordinary skill in the art to which this disclosure belongs.

As used herein, the term “standard temperature and pressure” generally refers to 25° C. and 1 atmosphere. Standard temperature and pressure may also be referred to as “ambient conditions.” Unless indicated otherwise, parts are by weight, temperature is in ° C., and pressure is at or near atmospheric. The terms “elevated temperatures” or “high-temperatures” generally refer to temperatures of at least 100° C.

The term “mol percent” or “mole percent” generally refers to the percentage that the moles of a particular component are of the total moles that are in a mixture. The sum of the mole fractions for each component in a solution is equal to 1.

It is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by prior disclosure. Further, the dates of publication provided could be different from the actual publication dates that may need to be independently confirmed.

Unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

The examples and embodiments described herein are for illustrative purposes only and that various modifications or changes in light thereof will be suggested to persons skilled in the art and are to be included within the spirit and purview of this application. Many variations and modifications may be made to the above-described embodiment(s) of the disclosure without departing substantially from the spirit and principles of the disclosure. All such modifications and variations are intended to be included herein within the scope of this disclosure.

### General Discussion

Various embodiments relate to gelling aqueous ceramic slurries with temperature using laser-assisted free-forming to provide a breakthrough of rapidly making ceramics from slurries and computer assisted design files. Methods according to various embodiments are superior to any other since no toxic materials are used. The slurries are made with edible and safe compounds.

Various embodiments relate to a method for additive manufacturing. The methods may utilize a slurry of ceramic or metallic particles in water or a solvent that can be gelled with warming from room temperature to about 65 degrees Celsius. The slurry may gel at a constant volume, such that no shrinkage occurs. According to various embodiments, the mixing of powder, dispersant and organic gelling agent achieves a constant volume process. As used herein, “constant volume” means there is only negligible shrinkage from liquid slurry to gelled slurry to dried part, typically less than 1%, often less than 0.1% linear shrinkage.

The thermo-responsive slurry may be spread as a thin layer via a blade or waterfall technique or drop by drop, spin-coating, dip-coating, or other suitable method. A laser with a frequency that couples into the ceramic particles, the liquid, the polymer or any dye that may be added may be used. The coupling into the system causes light absorption and localized heating from room temperature to about 65 degrees Celsius or higher. This results in localized gelling of the liquid slurry without volume change. The laser may be controlled by a computer software that allows changes in scanning speed, laser intensity, and spot width, as well as hatch distance. Three-dimensional (3D) parts may be built by subsequently spreading layers, followed by laser heating at the spots that need to be solidified. The non-heated parts remain as liquid and may, therefore, be easily separated at the end of the printing once the part is finished. Various embodiments may employ long wavelength lasers or light sources with masks. Typically, 2 micron to 10 micron wavelengths or longer are preferred. According to various embodiments, the laser may have a frequency that is absorbed by either water or solvent and thus induces heating of the dispersing medium. In another design the laser energy can be absorbed by the ceramic particles or a dye that may be added and in this way heat the dispersed or dissolved part of the system. Furthermore, a laser with a specific frequency could be used to be absorbed by any other component of the system. More so, a long wavelength (infrared) laser such as a CO₂ laser could be used that can be absorbed by several or all components of the system at the same time and thus heat the system more quickly and efficiently.

Various embodiments result in no residue of processing aids, which means that the manufactured structures may have clean grain boundaries, better microstructures, and better properties. The properties achieved according to various embodiments may match properties achieved by conventional fabrication techniques.

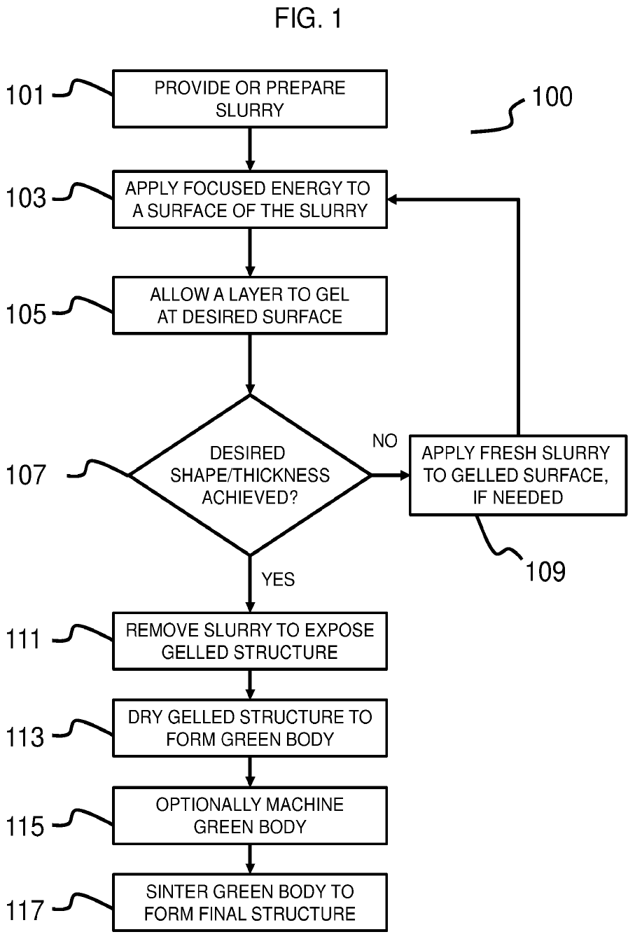

FIG. 1 is an example according to various embodiments illustrating a flow chart of a method 100 for laser-assisted solid freeform fabrication of ceramic materials via temperature sensitive slurries. The method 100 may include a step 101 of providing or preparing a slurry; a step 103 of applying focused energy to a surface of the slurry; and a step 105 of allowing a layer of the slurry to gel. The focused energy may be provided by a laser as described herein. A mask may be employed to help focus the energy provided by the laser. The slurry may comprise a slurry of ceramic or metallic particles in water or a solvent. The slurry may also comprise one or more proteins or polymers. Various embodiments may involve gelling organic compounds such as naturally occurring proteins, especially from industrial waste streams such as whey protein, or beta- lactoglobulin (milk industry waste from cheese making. Such embodiments may be especially important for waste stream of making Greek yoghurt. Whey form Greek yoghurt is too acidic to be used for food. This would be an ideal application for the waste.

Still referring to FIG. 1, the method 100 may further include a step 107 of determining whether the desired shape or thickness has been achieved. If the desired thickness has not been achieved, the method may include a step 109 of applying fresh slurry to the previously gelled surface and repeating steps 103, 105, and 107. Once the desired shape or thickness is achieved, the method 100 may proceed to a step 111 at which the slurry is removed to expose a gelled structure. The method 100 may then include a step 113 of drying the gelled structure to form a green body. The method may include an option step 115 of machining the green body. Finally, the method 100 may include a step of sintering the green body to form the final structure.

The following examples are put forth to provide those of ordinary skill in the art with a complete disclosure and description of how to perform the methods, how to make, and how to use the compositions and compounds disclosed and claimed herein. Efforts have been made to ensure accuracy with respect to numbers (e.g., amounts, temperature, etc.), but some errors and deviations should be accounted for. The purpose of the following examples is not to limit the scope of the various embodiments, but merely to provide examples illustrating specific embodiments.

### Mechanism for Gelation

According to various embodiments, the localized heat provided, for example, by the laser, triggers a phase change of a polymer or protein. This triggers a highly localized volume the increase in viscosity and as such gels and coagulates or flocculates the slurry at the point where the laser has heated the slurry.

The slurry can be made aqueous or non-aqueous, or mixtures thereof. Aqueous slurries are preferred since they do not dry out during the process and they also do not cause any hazardous vapors or explosive gas mixtures.

Polymers that show a transition from one phase to two phase regions in a solvent or water are numerous. In the examples provided herein, low molecular weight molecules that dissolve well in water and are non-toxic were employed, but a wide variety of polymers and proteins will be readily available and suitable.

For example, proteins from waste streams of the milk industry or proteins from chicken eggs may be employed. These proteins are water soluble at room temperature, but when heated they denature by losing their tertiary structure. This causes unraveling of beta-sheets, alpha helices or beta turns, turning them into random coil sections, thus exposing hydrophobic amino acid sequences such as tyrosine or tryptophan. These compounds precipitate out of water and cause the viscosity of the slurry to go up until the point where it gels. Gelling can occur via several pathways. First, the hydrophobized polymer may be driven out of water onto the hydrophilic particle surface. Particles thus turn hydrophobic and now coagulate out of water irreversibly. The slurry is gelled at constant volume. Secondly, the hydrophobized polymer may bridge the particles, i.e. flocculates the slurry. Thirdly, the hydrophobic polymer gels and the water and the particles are trapped in place. None of these mechanisms is dependent on the particle characteristics, i.e. all ceramic and metallic particle or systems can be processed with these compounds.

### EXAMPLES

### Introduction

The following examples are put forth to provide those of ordinary skill in the art with a complete disclosure and description of how to perform the methods, how to make, and how to use the compositions and compounds disclosed and claimed herein. Efforts have been made to ensure accuracy with respect to numbers (e.g., amounts, temperature, etc.), but some errors and deviations should be accounted for. The purpose of the following examples is not to limit the scope of the various embodiments, but merely to provide examples illustrating specific embodiments.

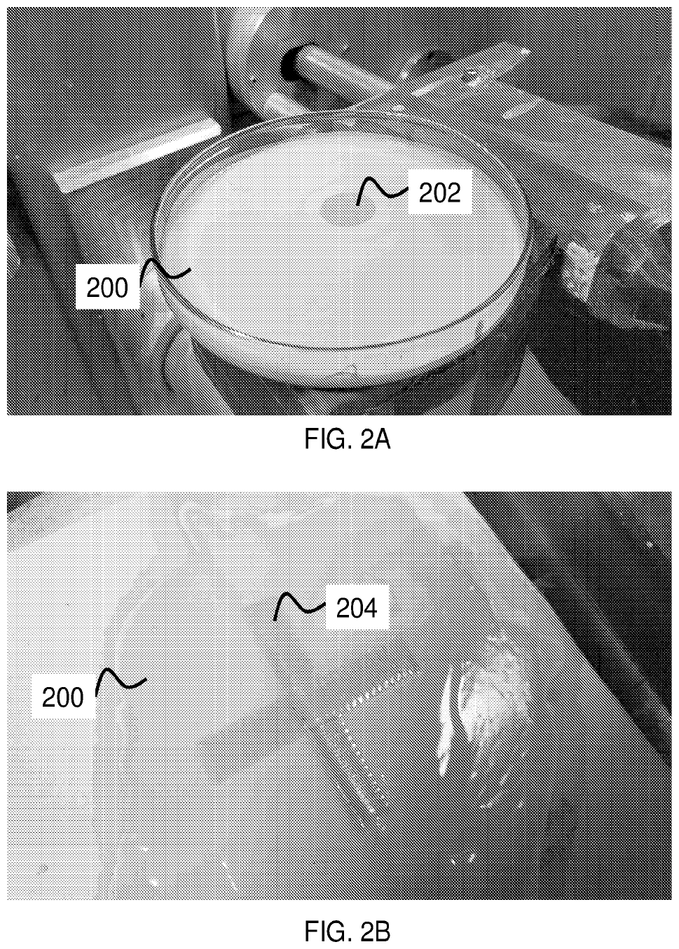

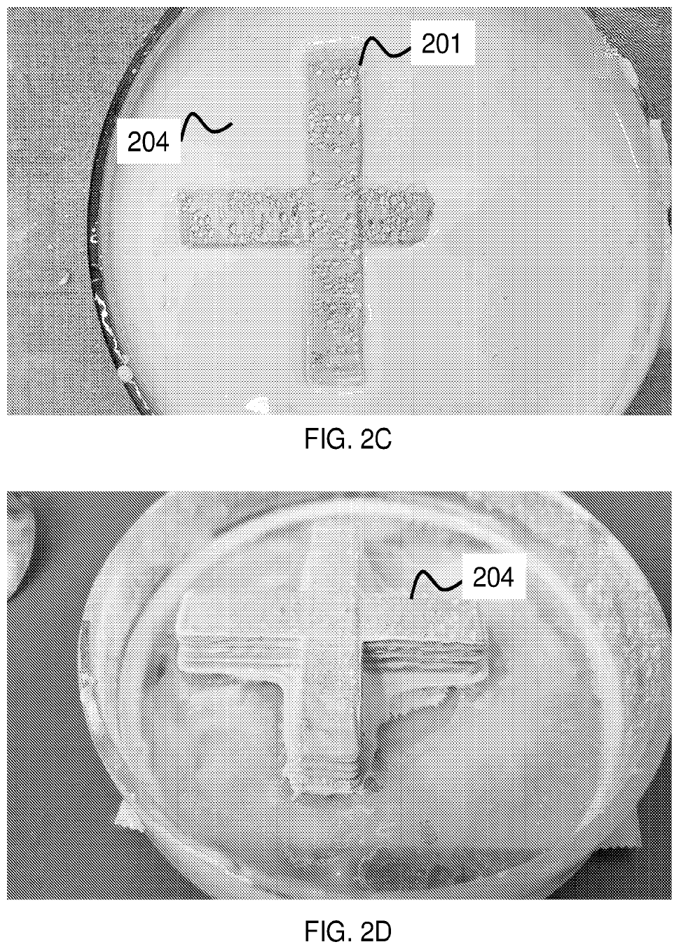

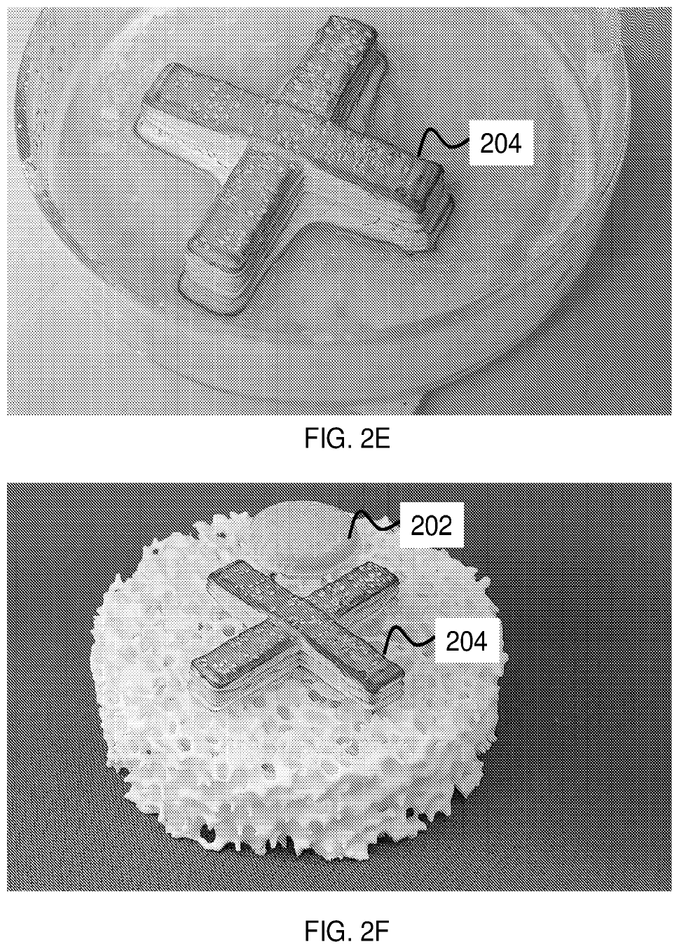

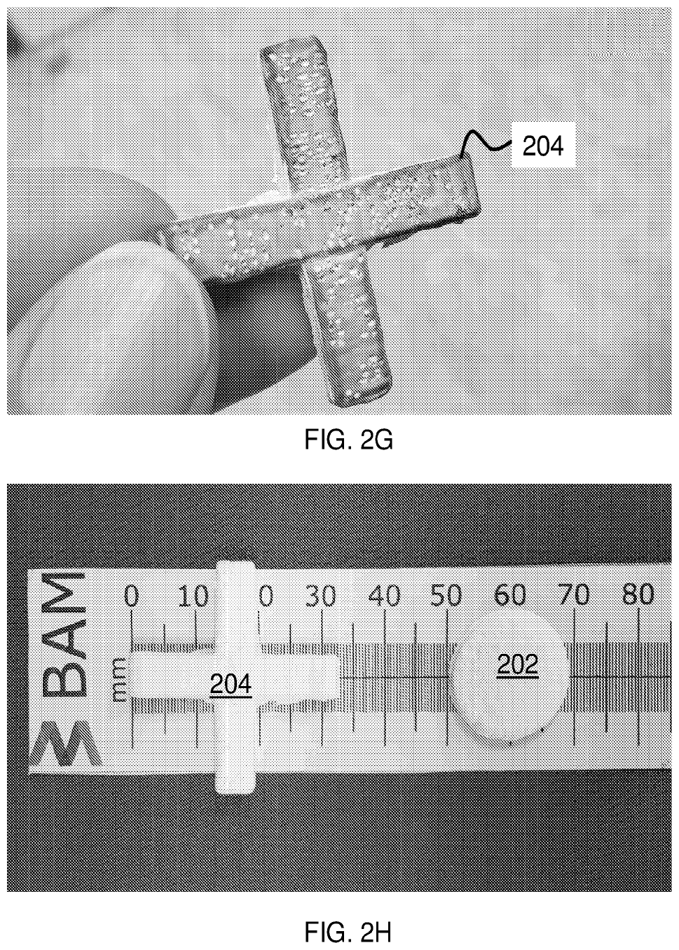

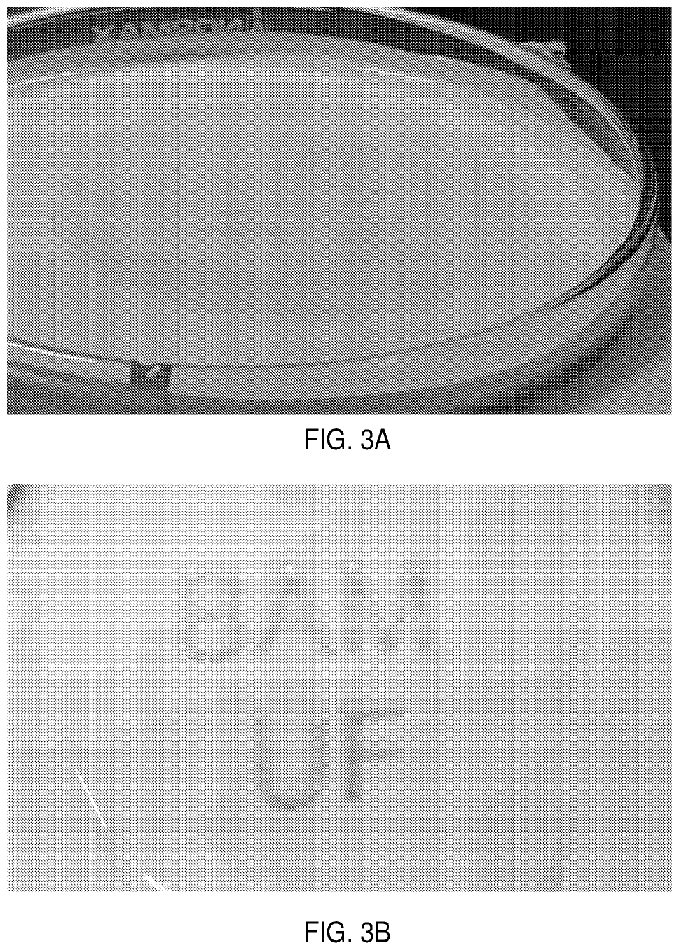

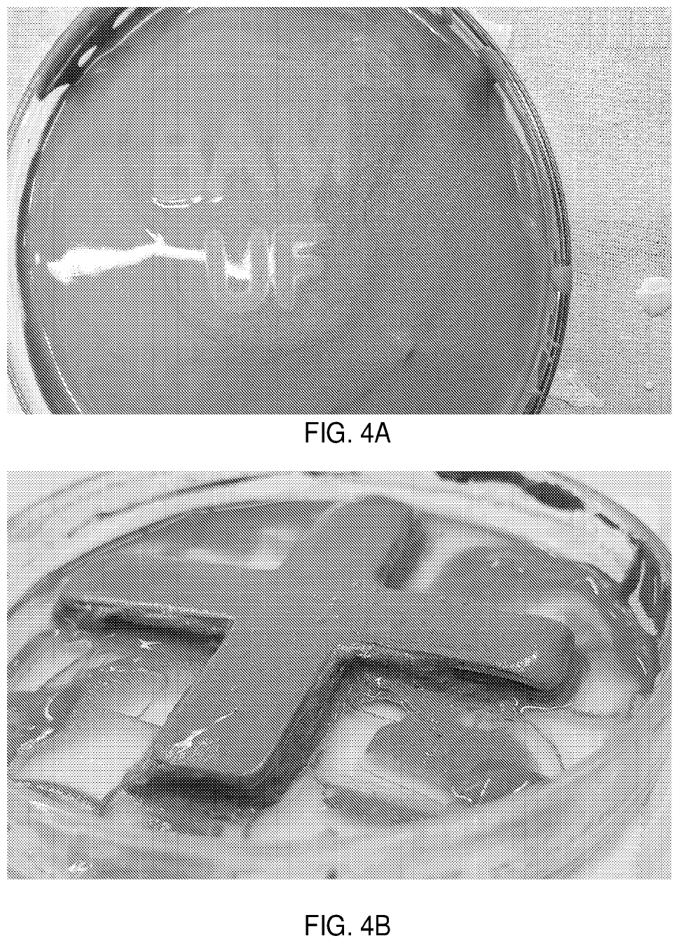

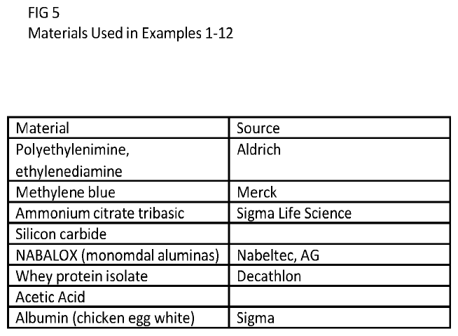

FIGS. 2A-2H illustrate various steps and products produced as described in the Example 1. FIGS. 3A-3B illustrate various steps and products produced as described in Example 2. FIGS. 4A-4B illustrate various steps and products produced as described in the Example 3. FIG. 5 provides a list of the materials used in Examples 1-12 to provide specific details.

### Example 1

A purpose of this example is to demonstrate the preparation of some three-dimensional structures, specifically a disk and a cross in an alumina-based slurry. The same general method was employed to produce both structures. The method included providing a slurry comprising alumina and whey protein. Focused energy was applied to the slurry by a laser to gel a portion of the slurry at which the laser is applied. The slurry was spread over the gelled portion and then scanned again by the laser to gel the new layer. This process was repeated to produce the final three-dimensional structure layer by layer. After the structure is produced, the slurry was removed. The resulting structure was allowed to dry and was then sintered. A laser system with 2 micron wavelength was used.

The alumina-based slurry was prepared by mixing 285 g Nabalox alpha alumina powder with 1.2 grams of triammonium citrate as dispersant that was dissolved in 60 grams of room temperature deionized water. Deionized water of <0.055 microSiemens conductivity was used. The slurry was milled for 24 hours on a roller mill in a polyethylene container using alumina grinding media. Ca. 1 cm alumina grinding media balls. Use of 550 g of grinding balls. Next, dissolve 6 grams of whey protein or chicken egg albumin in 10 grams of water at room temperature. Add this solution under mild shaking to the slurry, add 0.02 grams of methylene blue dye and 2 grams octanol. Mill gain (mixing) for 30 min. Separate slurry from grinding media using sieve. Use measured amount of deionized water to wash off slurry from grinding media. Do not exceed 20 mL. Ideally viscosity is in range from honey to water. Viscosity is most important for type of spreading. Manual spreading may work best, if viscosity of the slurry is close to water.

FIG. 2A is an example according to various embodiments, illustrating a slurry comprising alumina and whey protein gelled by laser. An area the size of disk 202 of the slurry 200 was scanned with a laser. Then another layer of slurry 200 was spread across the disk and it was scanned again by the laser. Spreading was done manually using a pipette. The gelled section turns a darker blue. The diameter of the disk 202 is 1 cm and the thickness of each layer is about 1 to 2 mm. A plurality of layers may be formed by repeating this procedure.

FIG. 2B is an example according to various embodiments, illustrating the printing of a cross 204 to test the constant volume of the technique in gelling and drying. A slurry 200 comprising alumina and whey protein was gelled by laser. It was discovered that if a constant volume of slurry 200 was not maintained, cracks would develop at the corners of the cross 204. The dimension of the cross 204 were 4 cm by 1 cm bars.

FIG. 2C is an example according to various embodiments, illustrating a cross 204 printed and slurry 200 being moved to empty the dish. A slurry 200 comprising alumina and whey protein was gelled by laser to produce the cross 204. One section of the cross 204 is covered with slurry from movement. The slurry 200 was easily cleared off by pouring.

FIG. 2D is an example according to various embodiments, illustrating the printed cross 204, as shown in FIG. 3, after separating from slurry 200. The cross 204 is shown in a wet state, meaning that its surface is still wetted by some remaining slurry 200.

FIG. 2E is an example according to various embodiments, illustrating the printed cross 204, as shown in FIG. 3, after separating from slurry 200 and after drying. No cracks were present in the corners of cross 204. It was discovered that the lack of cracks at the corners of the cross indicates that a shrinkage of slurry 200 relative to the dried part, here the cross 204, of less than 1% occurred. The method will allow larger parts in complex shape to be printed and dried without removing it from the printing base until after drying.

FIG. 2F is an example according to various embodiments, illustrating both the disk 202 and the printed cross 204 after drying and before sintering. As already discussed, both the disk 202 and the cross 204 were based on top of a porous alumina sintering support.

FIG. 2G is an example according to various embodiments, illustrating the dried green body, specifically the cross 204, is stable for handling by hand prior to sintering. The dried green body may be machined, for example with drilling, polishing, and/or cutting, if needed.

FIG. 2H is an example according to various embodiments, illustrating the disk 202 and cross 204 after sintering. The alumina is now white since the laser coupling dye has been burnt out. Sintered parts reflect the dimensions of the printed parts following the standard shrinkage rules in all three dimensions.

### Example 2

A purpose of this example is to demonstrate the preparation of some additional three-dimensional structures, specifically letters. The same alumina slurry described above in Example 1 was used. A laser system with 2 micron wavelength was used.

FIG. 3A is an example according to various embodiments, illustrating printing the letters BAM and UF on top of a disk with the alumina slurry.

FIG. 3B is an example according to various embodiments, illustrating differences in the gelled (letters) and liquid slurry (all around) are visible for the alumina system. The dye that the laser coupled into to gel the system becomes more pronounced.

### Example 3

A purpose of this example is to demonstrate the preparation of some additional three-dimensional structures, specifically letters and a cross in a silicon carbide-based slurry. A laser system with 2 micron wavelength was used.

The silicon carbide-based slurry was prepared by mixing silicon carbide (SiC) powder 321 grams, deionized water 105 grams, PEI 4 grams, 180 grams of alumina grinding media 1 cm. 7.4 grams of glacial acetic acid to adjust pH to 7, 3 mL Octanol as defoamer and 6 grams al egg albumin as gelling agent. To adjust viscosity for manual spreading another 50 grams of water was added (used for dissolving egg albumin before adding. Deionized water of <0.055 microSiemens conductivity was used.

FIG. 4A is an example according to various embodiments, illustrating printing Silicon Carbide (SiC) slurry with disk base and BAM UF letters on top.

FIG. 4B is an example according to various embodiments, illustrating printed cross again with no cracks in the corners verifying the constant volume technique that will allow big parts to be built.

### Computational Hardware Overview

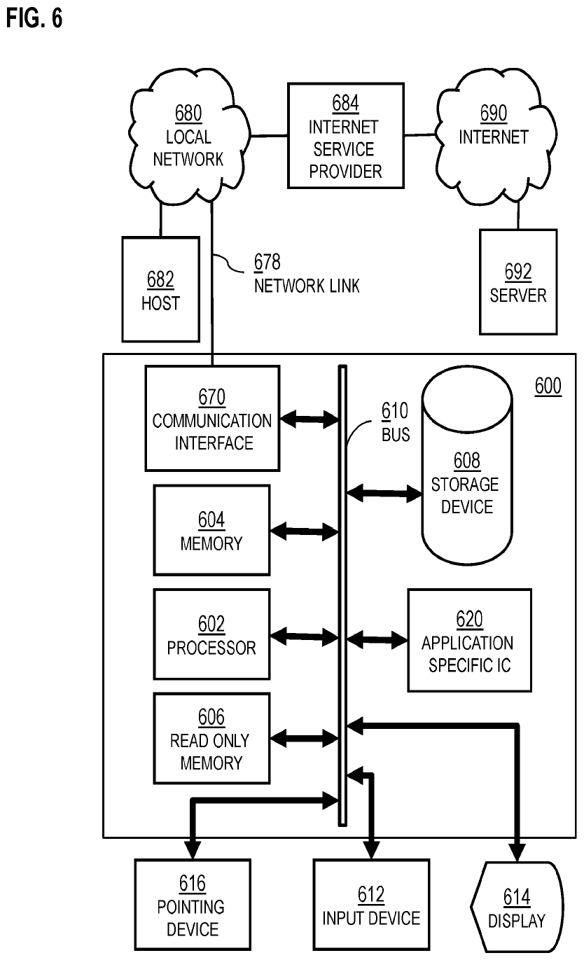

According to various embodiments, the laser may be controlled by a computer software that allows changes in scanning speed, laser intensity, and spot width, as well as hatch distance. The computer software may be implemented on a computer system 600, as illustrated, for example, in FIG. 6.

FIG. 6 is a block diagram that illustrates a computer system 600 upon which an embodiment of the invention may be implemented. Computer system 600 includes a communication mechanism such as a bus 610 for passing information between other internal and external components of the computer system 600. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of one or more methods described herein.

A sequence of binary digits constitutes digital data that is used to represent a number or code for a character. A bus 610 includes many parallel conductors of information so that information is transferred quickly among devices coupled to the bus 610. One or more processors 602 for processing information are coupled with the bus 610. A processor 602 performs a set of operations on information. The set of operations include bringing information in from the bus 610 and placing information on the bus 610. The set of operations also typically include comparing two or more units of information, shifting positions of units of information, and combining two or more units of information, such as by addition or multiplication. A sequence of operations to be executed by the processor 602 constitutes computer instructions.

Computer system 600 also includes a memory 604 coupled to bus 610. The memory 604, such as a random access memory (RAM) or other dynamic storage device, stores information including computer instructions. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of computer instructions. The computer system 600 also includes a read only memory (ROM) 606 or other static storage device coupled to the bus 610 for storing static information, including instructions, that is not changed by the computer system 600. Also coupled to bus 610 is a non-volatile (persistent) storage device 608, such as a magnetic disk or optical disk, for storing information, including instructions, that persists even when the computer system 600 is turned off or otherwise loses power.

Information, including instructions, is provided to the bus 610 for use by the processor from an external input device 612, such as a keyboard containing alphanumeric keys operated by a human user, or a sensor. A sensor detects conditions in its vicinity and transforms those detections into signals compatible with the signals used to represent information in computer system 600. Other external devices coupled to bus 610, used primarily for interacting with humans, include a display device 614, such as a cathode ray tube (CRT) or a liquid crystal display (LCD), for presenting images, and a pointing device 616, such as a mouse or a trackball or cursor direction keys, for controlling a position of a small cursor image presented on the display 614 and issuing commands associated with graphical elements presented on the display 614.

In the illustrated embodiment, special purpose hardware, such as an application specific integrated circuit (IC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 670 sends and receives electrical, acoustic or electromagnetic signals, including infrared and optical signals, that carry information streams, such as digital data.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 602, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 602, except for carrier waves and other signals.

Logic encoded in one or more tangible media includes one or both of processor instructions on a computer-readable storage media and special purpose hardware, such as ASIC 620.

Network link 678 typically provides information communication through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690. A computer called a server 692 connected to the Internet provides a service in response to information received over the Internet. For example, server 692 provides information representing video data for presentation at display 614.

The invention is related to the use of computer system 600 for implementing the techniques described herein. According to one embodiment of the invention, those techniques are performed by computer system 600 in response to processor 602 executing one or more sequences of one or more instructions contained in memory 604. Such instructions, also called software and program code, may be read into memory 604 from another computer-readable medium such as storage device 608. Execution of the sequences of instructions contained in memory 604 causes processor 602 to perform the method steps described herein. In alternative embodiments, hardware, such as application specific integrated circuit 620, may be used in place of or in combination with software to implement the invention. Thus, embodiments of the invention are not limited to any specific combination of hardware and software.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server 692 transmits program code for a particular application, requested by a message sent from computer 600, through Internet 690, ISP equipment 684, local network 680 and communications interface 670. The received code may be executed by processor 602 as it is received, or may be stored in storage device 608 or other non-volatile storage for later execution, or both. In this manner, computer system 600 may obtain application program code in the form of a signal on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red a carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

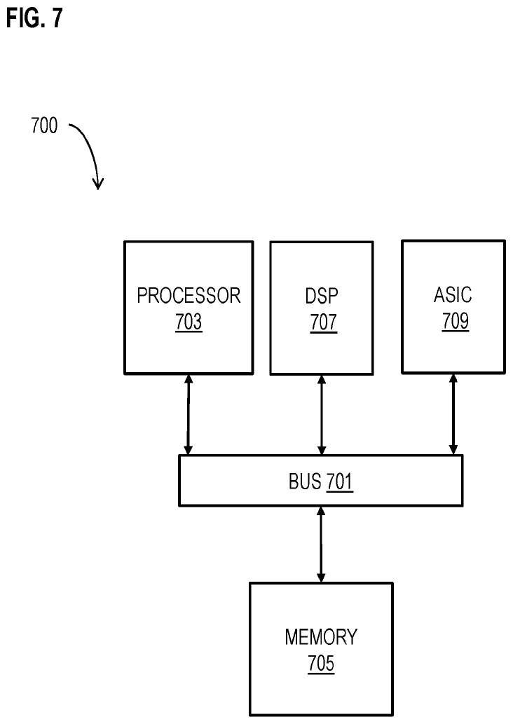

FIG. 7 illustrates a chip set 700 upon which an embodiment of the invention may be implemented. Chip set 700 is programmed to perform one or more steps of a method described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 700, or a portion thereof, constitutes a means for performing one or more steps of a method described herein.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 705 also stores the data associated with or generated by the execution of one or more steps of the methods described herein.

What is claimed is:

1. A method for producing a ceramic material comprising:
applying energy to a surface of a slurry, the slurry comprising a ceramic precursor and a gellable material,
wherein applying the energy is sufficient to gel the gellable material at the surface to form a gel layer comprising the ceramic precursor;
optionally applying additional slurry to the gel layer and applying additional energy to form an additional gel layer;
removing the slurry to expose a gelled structure;
drying the gelled structure to form a green body;
optionally machining the green body; and
sintering the green body to produce the ceramic material.

2. The method according to claim 1, wherein the ceramic precursor is selected from the group consisting of a ceramic material, a metallic material, and combinations thereof.

3. The method according to claim 2, wherein the ceramic material is a crystalline or glass/amorphous ceramic material.

4. The method according to claim 2, wherein the ceramic precursor is a ceramic material, and wherein the ceramic material is selected from the group consisting of silicon carbide, alumina, and combinations thereof.

5. The method according to claim 2, wherein the ceramic precursor is a metallic material, and wherein the metallic material is selected from the group consisting of main group metallic elements of the periodic table, transition metals, actinides, lanthanides, and combinations thereof.

6. The method according to claim 1, wherein the gellable material is selected from the group consisting of a polymeric material, a protein, a glycoprotein, and combinations thereof.

7. The method according to claim 6, wherein the gellable material is a polymeric material, and wherein the polymeric material is derived from natural or synthetic amino acid monomers and combinations thereof.

8. The method according to claim 6, wherein the gellable material is a protein, and wherein the protein is selected from the group consisting of whey, albumin, beta-lactoglobulin, and combinations thereof.

9. The method according to claim 1, wherein the slurry further comprises a solvent selected from the group consisting of water, alcohols, esters, oligo- or poly-ethers, ketones, and combinations thereof.

10. The method according to claim 1, wherein applying the energy to the surface of the slurry comprises directing a laser at the surface.

11. A product comprising a ceramic material produced by a process comprising:
applying energy to a surface of a slurry, the slurry comprising a ceramic precursor and a gellable material,
wherein applying the energy is sufficient to gel the gellable material at the surface to form a gel layer comprising the ceramic precursor;
optionally applying additional slurry to the gel layer and applying additional energy to form an additional gel layer;
removing the slurry to expose a gelled structure;
drying the gelled structure to form a green body;
optionally machining the green body; and
sintering the green body to produce the ceramic material.

12. The product according to claim 11, wherein the product has a complex shape, comprising a plurality of edges and corners.

13. The product according to claim 11, wherein the product is produced without a mold in near net shape.

14. The product according to claim 11, wherein the product does not require final machining to match engineering dimensions.

15. The product according to claim 14, wherein the engineering dimensions have tolerances of at least about +/−10 micrometers.
